(19) United States
(12) Patent Application Publication
(10) Pub. No.: US 2014/0073422 A1
(43) Pub. Date: Mar. 13, 2014

(54) INITIALIZING AND AUTHENTICATING WAGERING GAME MACHINES

(71) Applicant: WMS Gaming, Inc., Waukegan, IL (US)

(72) Inventors: Craig J. Sylla, Round Lake, IL (US); Timothy D. Wilson, Oak Park, IL (US)

(73) Assignee: WMS Gaming, Inc., Waukegan, IL (US)

(21) Appl. No.: 14/082,778

(22) Filed: Nov. 18, 2013

Related U.S. Application Data
(62) Division of application No. 12/601,160, filed on Nov. 20, 2009.
(60) Provisional application No. 60/947,166, filed on Jun. 29, 2007.

(51) Int. Cl. G07F 17/32

(52) U.S. Cl. CPC G07F 17/3241
USPC 463/29

(57) ABSTRACT

Methods and apparatus for initializing and authenticating wagering game machines are described herein. In one embodiment, the method includes receiving a digital certificate from a mobile wagering game machine. The method can also include determining that the digital certificate is authentic and selecting wagering game content and services that are available to the mobile wagering game machine. The method can also include transmitting some of the available wagering game content to the mobile wagering game machine.

### RELATED APPLICATIONS

This application is a Divisional that claims priority of United States of America patent application Ser. No. 12/601,160, which is a 371 application of PCT/US2008/067954 filed on Jun. 24, 2008. The international patent application PCT/US2008/067954 claims benefit of U.S. Provisional Application No. 60/947,166, which was filed Jun. 29, 2007.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to wagering game systems, and more particularly to processing authentication credentials in wagering game networks.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 is a dataflow diagram illustrating dataflow and operations for using digital certificates to authenticate and determine content for a mobile machine, according to some embodiments of the invention;

FIG. 2 is a block diagram illustrating a wagering game network 200, according to example embodiments of the invention;

FIG. 3 is a block diagram illustrating an architecture for a wagering game machine, according to example embodiments of the invention;

FIG. 4 illustrates a digital certificate for use in a wagering game network, according to some embodiments of the invention;

FIG. 5 is a flow diagram illustrating operations for initializing a wagering game machine, according to some embodiments of the invention;

FIG. 6 is a flow diagram illustrating operations for processing digital certificates and exchanging wagering game content, according to some embodiments of the invention;

FIG. 7 is a flow diagram illustrating operations for distributing digital certificates in a wagering game network, according to some embodiments of the invention;

FIG. 8 is a flow diagram illustrating operations for processing a request to revoke a digital certificate, according to some embodiments of the invention; and

FIG. 9 shows an example embodiment of a wagering game machine, according to some embodiments of the invention.

### DESCRIPTION OF THE EMBODIMENTS

This description of the embodiments is divided into five sections. The first section provides an introduction to embodiments of the invention, while the second section describes an example operating environment. The third section describes example operations performed by some embodiments and the fourth section describes example wagering game machines in more detail. The fifth section presents some general comments.

### Introduction

This section provides an introduction to some embodiments of the invention. Wagering game machines are typically large stationary devices. However, some wagering game machines are lightweight handheld devices designed for mobility. This mobility enables players to play wagering games in a wide variety of casino settings, such as by a casino pool, in a sports book, in a casino restaurant, etc.

Mobile wagering game machines (hereinafter “mobile machines”) may be exposed to security risks not common to their stationary counterparts. For example, attackers can move mobile machines to clandestine locations that are free of casino security. Absent casino security, attackers can attempt to modify mobile machines with relative impunity. Attackers can use modified wagering game machines to commit fraud over wagering game networks and/or perform other rouge operations. However, some embodiments of the invention make wagering game networks more resistant to attack. For example, some mobile machines cannot access wagering game networks without first proving their authenticity using digital certificates. In some embodiments, the digital certificates are revoked when mobile machines report attacks and/or when they lose communication with certain network devices (e.g., wagering game servers). The revocation of digital certificates may be frequent, as the mobile machines may frequently report attacks and/or frequently lose communications with wagering game servers. Therefore, embodiments of the invention enable wagering game networks to proactively discover potentially rogue mobile machines and deny them access to the network.

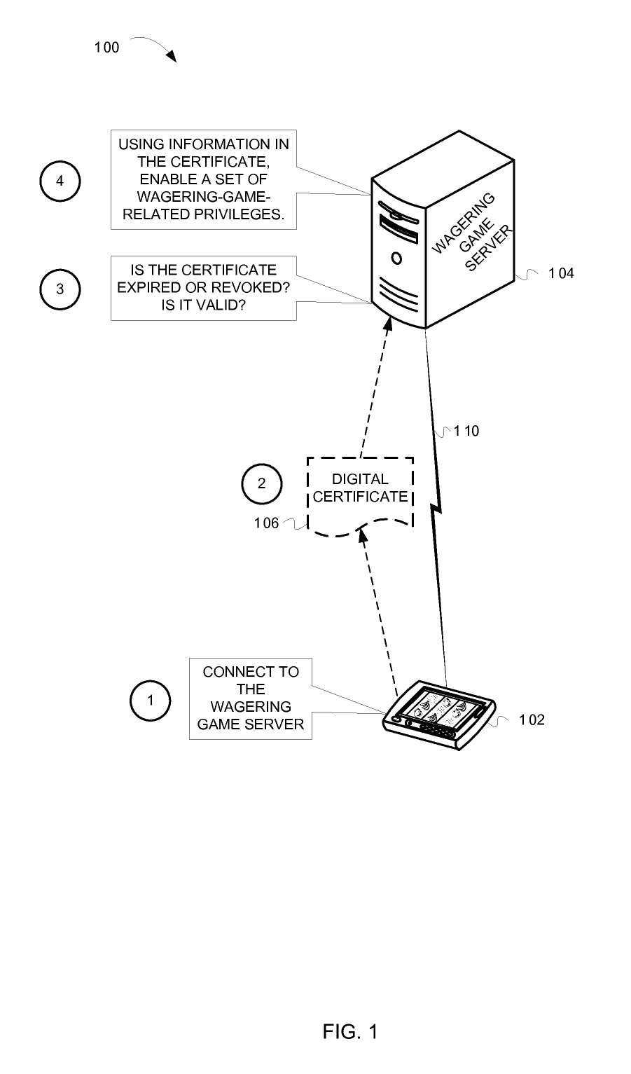

As yet another feature, some wagering game network components (e.g., wagering game servers) can process the digital certificates to determine what content and/or services will be made available to mobile wagering game machines. FIG. 1 describes the above-noted features in more detail.

FIG. 1 is a dataflow diagram illustrating dataflow and operations for using digital certificates to authenticate and determine content for a mobile machine, according to some embodiments of the invention. In FIG. 1, a wagering game network 100 includes a mobile machine 102 connected to a wagering game server 104 over a network connection 110. The mobile machine 102 is configured to present wagering games and facilitate services using content received from the wagering game server 104. However, before facilitating wagering games and services, the wagering game server 104 uses digital certificates to authenticate the mobile machine 102. Dataflow and operations for authenticating the mobile machine 102 and determining content occur in four stages.

During stage one, the mobile machine 102 establishes communications with the wagering game server 104. During stage two, the mobile machine 102 provides a digital certificate 106 to the wagering game server 104. During stage three, the wagering game server 104 determines whether the digital certificate 106 is valid. That is, the wagering game server 104 determines whether the digital certificate 106 is expired, revoked, modified, etc. After determining the digital certificate 106 is valid, the wagering game server 104 proceeds with stage four. During stage four, the wagering game server 104 uses information in the digital certificate 106 to determine what content and services are available to the mobile machine 102. For example, the digital certificate 106 can indicate that the mobile machine 102 is limited to slots games and no services. Alternatively, the digital certificate 106 can indicate the mobile machine can play all available wagering game types (slots, black jack, poker, etc.) and can use an electronic drink ordering service.

Although FIG. 1 describes some embodiments, the following sections describe many other features and embodiments.

### Operating Environment

This section describes an example operating environment and provides structural aspects of some embodiments. In some embodiments, the structural components described herein can be further integrated, divided, and/or remotely distributed. This section includes discussion about wagering game machines, wagering game networks, and digital certificates.

### Wagering Game Networks

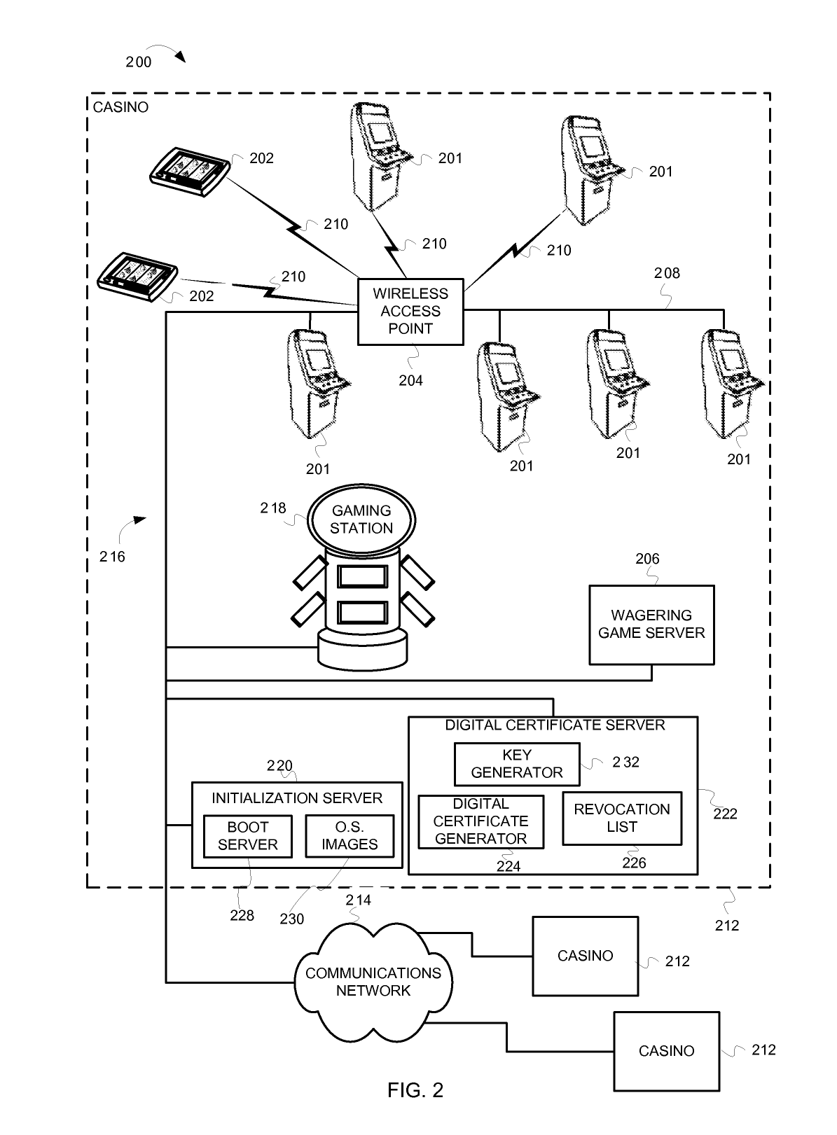

FIG. 2 is a block diagram illustrating a wagering game network 200, according to example embodiments of the invention. As shown in FIG. 2, the wagering game network 200 includes a plurality of casinos 212 connected to a communications network 214.

Each casino 212 includes a local area network 216, which includes an access point 204, wagering game machines 201 & 202, gaming station 218, wagering game server 206, initialization server 220, and digital certificate server 222. The access point 204 provides wireless communication links 210 and wired communication links 208. The wired and wireless communication links can employ any suitable connection technology, such as Bluetooth, 802.11, Ethernet, public switched telephone networks, SONET, etc. In some embodiments, the wired communication links 208 (and other LAN components) are physically secured against unauthorized access.

The wagering game machines described herein can take any suitable form, such as stationary floor models 201 (hereinafter “stationary machines”), handheld mobile models 202 (i.e., mobile machines), bartop models, workstation-type console models, etc. Moreover, any of the wagering game machines can be primarily dedicated for use in conducting wagering games, or they can include non-dedicated devices, such as mobile phones, personal digital assistants, personal computers, etc.

In some embodiments, players check-out mobile machines 202 from the gaming station 218, which can store, recharge, and securely connect the mobile machines 202 to the initialization server 220. While residing in the gaming station 218, the mobile machines 202 can perform an initialization process before they are removed for use in the casino 212. In some embodiments, as part of the initialization process, the mobile machines 202 can: 1) boot using operating systems received from the initialization server 220, and 2) securely receive digital certificates generated by the digital certificate server 222. After the mobile machines 202 initialize over the secure connection, they are ready to wirelessly connect to and authenticate with the wagering game server 206. Additional details about authentication and operation are described in the next section.

The initialization server 220 can include a boot server 228, operating system images 230, components for verifying authenticity of content (not shown), etc. In some embodiments, the boot server connects to wagering game machines 201 & 202 and transmits copies of the operating system image. The boot server can operate according to Intel Corporation's Preboot Execution Environment (PXE) standard and the operating system image can include any suitable operating system (e.g., one or more versions of Linux, UNIX, Windows, etc.).

The digital certificate server 222 can generate digital certificates, which can be used for authentication and selecting content and services for the wagering game machines 201 & 202. The digital certificate server 222 includes a digital certificate generator 224, key generator 232, and revocation list 226. In some embodiments, the digital certificate generator 224 can generate X.509 digital certificates, while the revocation list indicates digital certificates that have been revoked. In some embodiments, devices that present revoked certificates will be denied access to the wagering game network and will be treated as rogue devices.

In some embodiments, the digital certificate server 222 provides digital certificates to the initialization server 220 for distribution when the mobile machines 202 undertake the initialization process. The digital certificates can include information for authenticating wagering game machines and for defining wagering game content and services available to the wagering game machines. For example, the digital certificates can include public keys for authenticating devices and encrypting content.

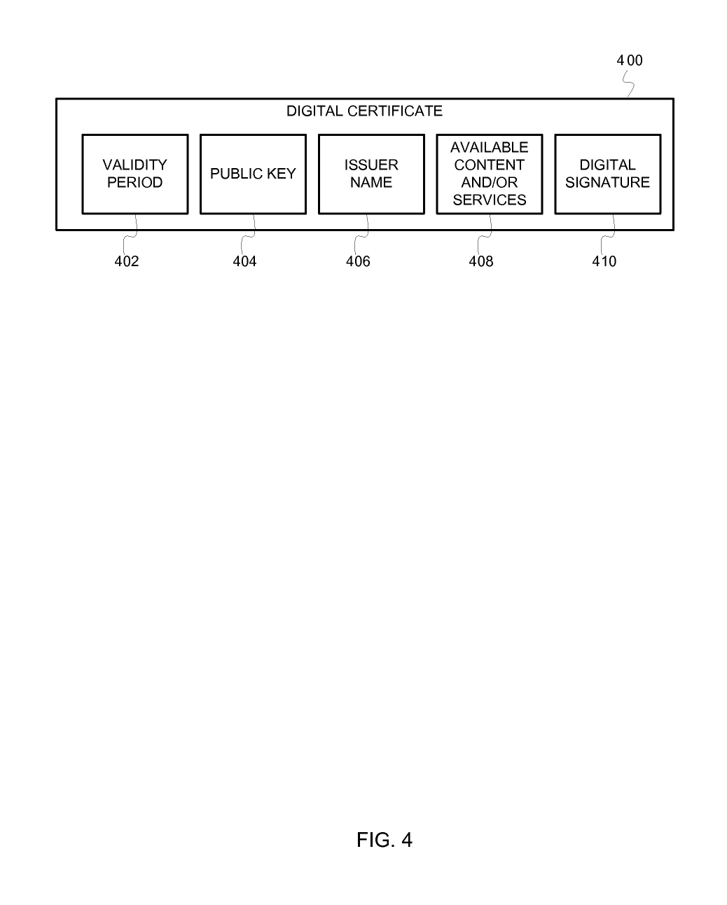

The digital certificate server 222 also includes a key generator 232 that can generate private cryptographic keys (and public keys) for distribution to network devices, where the private keys are associated with public keys included in the digital certificates. The private keys can be used in concert with the public keys to authenticate devices and to encrypt/decrypt content. In some embodiments, some wagering game network devices (e.g., mobile machines) can generate their own private keys for use in concert with public keys included in the digital certificates. Digital certificates will be described in more detail below (see discussion of FIG. 4).

The wagering game server 206 can authenticate wagering game network devices, serve wagering games, distribute content, and facilitate services for the wagering game machines 201 & 202. The wagering game machines 201 & 202 can operate as thin, thick, or intermediate clients. For example, one or more elements of game play may be controlled by the wagering game machine 201 & 202 (client) or the wagering game server 206 (server). Game play elements can include executable game code, lookup tables, configuration files, game outcome, audio or visual representations of the game, game assets or the like. In a thin-client example, the wagering game server 206 can perform functions such as determining game outcome or managing assets, while the wagering game machine 201 & 202 can present a graphical representation of such outcome or asset modification to the user (e.g., player). In a thick-client example, the wagering game machines 201 & 202 can determine game outcomes and communicate the outcomes to the wagering game server 206 for recording or managing a player's account.

In some embodiments, either the wagering game machines 201 & 202 (client) or the wagering game server 206 can provide functionality that is not directly related to game play. For example, account transactions and account rules may be managed centrally (e.g., by the wagering game server 206) or locally (e.g., by a wagering game machine 201/202). Other functionality not directly related to game play may include power management, presentation of advertising, software or firmware updates, system quality checks, etc.

In some embodiments, the wagering game network 200 can include other network devices, such as accounting servers, wide area progressive servers, player tracking servers, and/or other devices suitable for use in connection with embodiments of the invention. Any of the wagering game network components (e.g., the wagering game machines 201 & 202) can include hardware and machine-readable media including instructions for performing the operations described herein.

### Wagering Game Machine Architecture

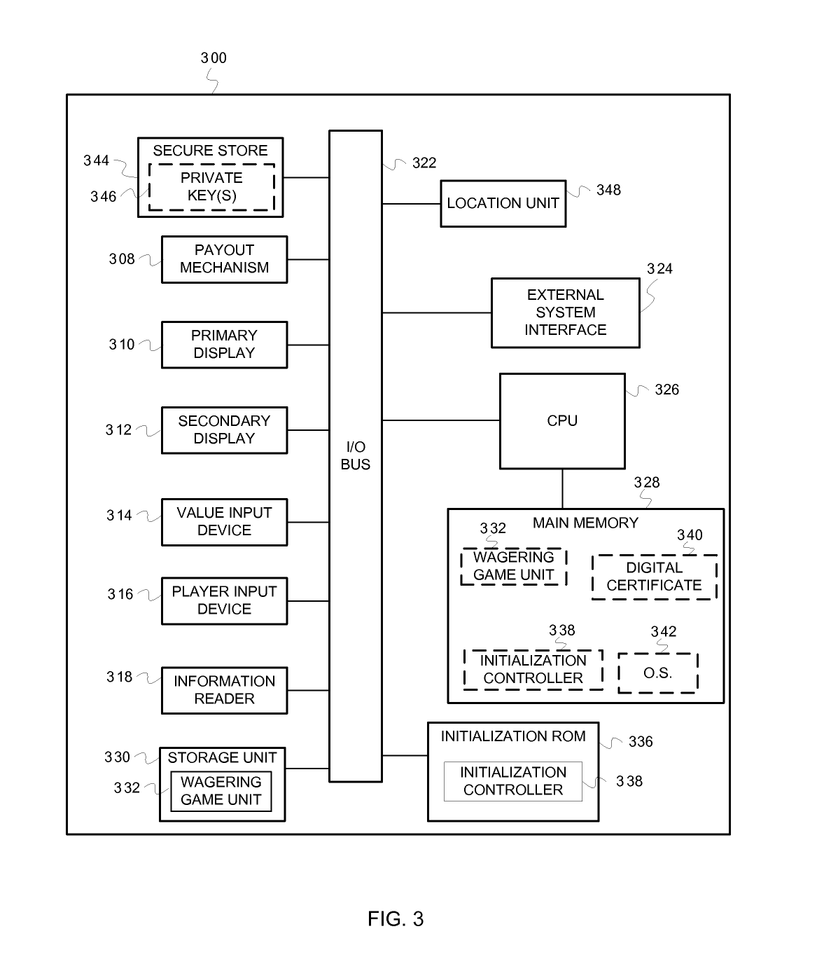

FIG. 3 is a block diagram illustrating an architecture for a wagering game machine, according to example embodiments of the invention. The wagering game machine 300 can be a mobile model, stationary model, etc. As shown in FIG. 3, the wagering game machine 300 includes a central processing unit (CPU) 326 connected to main memory 328. The CPU 326 can include any suitable processor, such as an Intel® Pentium processor, Intel® Core 2 Duo processor, AMD Opteron™ processor, or U1traSPARC processor.

The main memory 328 includes an initialization controller 338, wagering game unit 332, digital certificates 340, and operating system 342. In some embodiments, the initialization controller 338, operating system 342, and digital certificate 340 are loaded into the main memory 328 during an initialization process. In some embodiments, the initialization controller 338 controls a boot process during which the wagering game machine 300 receives the operating system 342 and digital certificate 340 from a trusted initialization server via a secure network link. After initialization is complete, the wagering game unit 332 can connect to and authenticate with a wagering game server or other network device. As part of the authentication process, the wagering game machine can present the wagering game server a copy of the digital certificate 340. After authentication, the wagering game machine 300 can present wagering games (e.g., video poker, video black jack, video slots, video lottery, etc.) and facilitate services (e.g., virtual concierge services, online beverage ordering, etc.). In some embodiments, the availability of wagering games and services is determined by content included in the digital certificate 340.

The CPU 326 is also connected to an input/output (I/O) bus 322, which can include any suitable bus technologies, such as an AGTL+frontside bus and a PCI backside bus. The I/O bus 322 is connected to an external system interface 324, payout mechanism 308, primary display 310, secondary display 312, value input device 314, player input device 316, information reader 318, storage unit 330, initialization read only memory (ROM) 336, and secure store 344.

In some embodiments, the initialization ROM 336 loads the initialization controller 338 into main memory 328 during an initialization process. In some embodiments, the initialization controller 338 can include a basic input/output system (BIOS) and network booting extensions.

The secure store 344 includes a private key 346, which can be associated with public keys included in the digital certificate 340. In some embodiments, the secure store 344 includes logic for generating the private key 346, while in other embodiments, the wagering game machine receives the private key 346 from the digital certificate server 222. In some embodiments, the secure store 344 can include a trusted platform module (TPM) chip. In some embodiments, before check-out, mobile machines can receive digital certificates in their secure stores 344.

The I/O bus 322 is also connected to a location unit 348. The location unit 348 can create information that indicates the wagering game machine's location in a casino. In some embodiments, the location unit 348 includes a global positioning system (GPS) receiver that can determine the wagering game machine's location using GPS satellites. In other embodiments, the location unit 348 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location.

In some embodiments, the wagering game machine 306 can include additional peripheral devices and/or more than one of each component shown in FIG. 3. For example, in some embodiments, the wagering game machine 306 can include multiple external system interfaces 324 and/or multiple CPUs 326. Although some components are depicted as software, any component of the wagering game machine 300 can be implemented as hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

### Digital Certificates

FIG. 4 illustrates a digital certificate for use in a wagering game network, according to some embodiments of the invention. FIG. 4 shows a digital certificate 400. The digital certificate 400 can conform to the X.509 standard, other suitable standards, and/or proprietary formats. The digital certificate 400 includes fields indicating a validity period, public key, issuer name, available content and/or services, and a digital signature. The validity period field 402 indicates a time period in which the digital certificate 400 can be used (e.g., to authenticate a wagering game network device, such as a mobile machine). In some embodiments, devices presenting expired digital certificates will not be granted access to the wagering game network and will not be viewed as authenticate devices.

The public key field 404 includes a public encryption key (“public key”). Devices can use the public key for encrypting, decrypting, and authenticating content. The public key can be associated with a particular wagering game network device. For example, the public key can be associated with the wagering game server 206. Thus, after a mobile machine acquires a digital certificate 400, the mobile machine can use the certificate's public key (contained in the public key field 404) to encrypt, decrypt, and authenticate content sent to and received from the wagering game server 206. The public key can also be associated with a private key known only to a wagering game network device, such as a mobile machine. The wagering game network device can utilize the private key in concert with a public key for encrypting messages and authenticating the device. In some embodiments, the digital certificate server 222 can distribute private keys associated with its digital certificates.

The issuer name field 406 can indicate what device or authority issued the digital certificate 400.

The available content field 408 can indicate wagering game content and/or services available to a network device (e.g., mobile machine) that presents the digital certificate 400. Available content and/or services can be indicated in bit strings, data fields, or any other suitable data structure. The data structure may be encoded to indicate more content and/or service options. In embodiments in which the digital certificate 400 conforms to the X.509 standard, user-defined portions of the certificate can include data indicating content and services available on a wagering game machine.

The digital signature field 410 can include a digital signature from a digital certificate authority (e.g., the digital certificate server 222). In some embodiments, the certificate authority creates the digital signature using it's own private cryptographic key. The certificate's digital signature can be verified using the certificate authority's public key.

### Example Operations

This section describes operations associated with some embodiments of the invention. In the discussion below, the flow diagrams will be described with reference to the block diagrams presented above. In certain embodiments, the operations are performed by executing instructions residing on machine-readable media (e.g., software), while in other embodiments, the operations are performed by hardware and/or other logic (e.g., firmware). In some embodiments, the operations are performed in series, while in other embodiments, one or more of the operations can be performed in parallel. Some embodiments perform less than all the operations shown in the flow diagrams. Moreover, despite the following headings, different components can perform the operations described below.

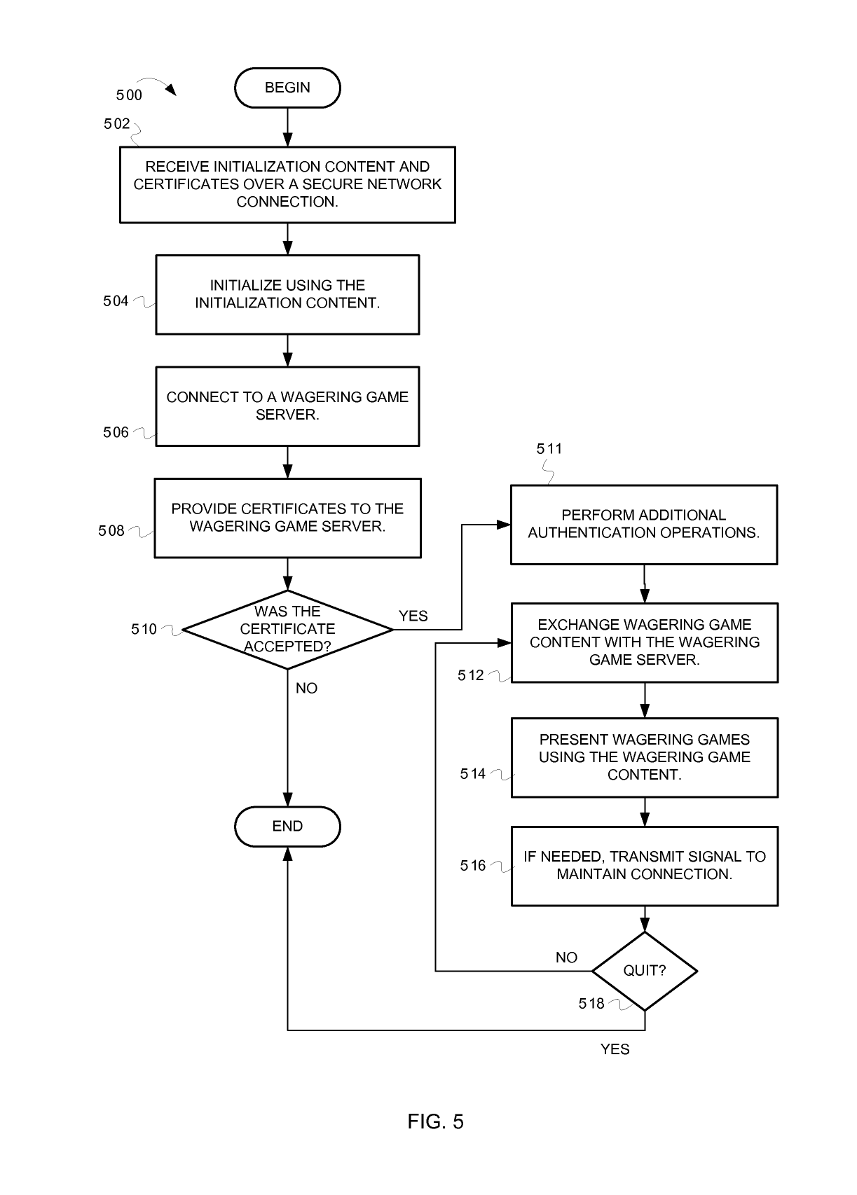

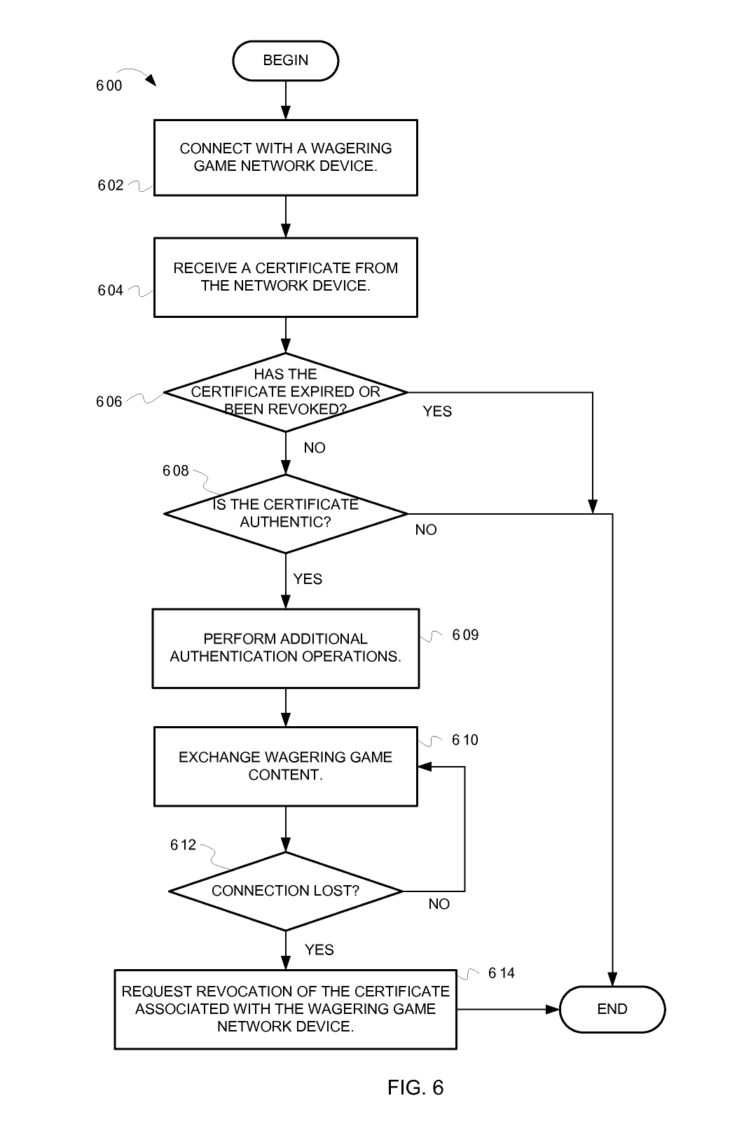

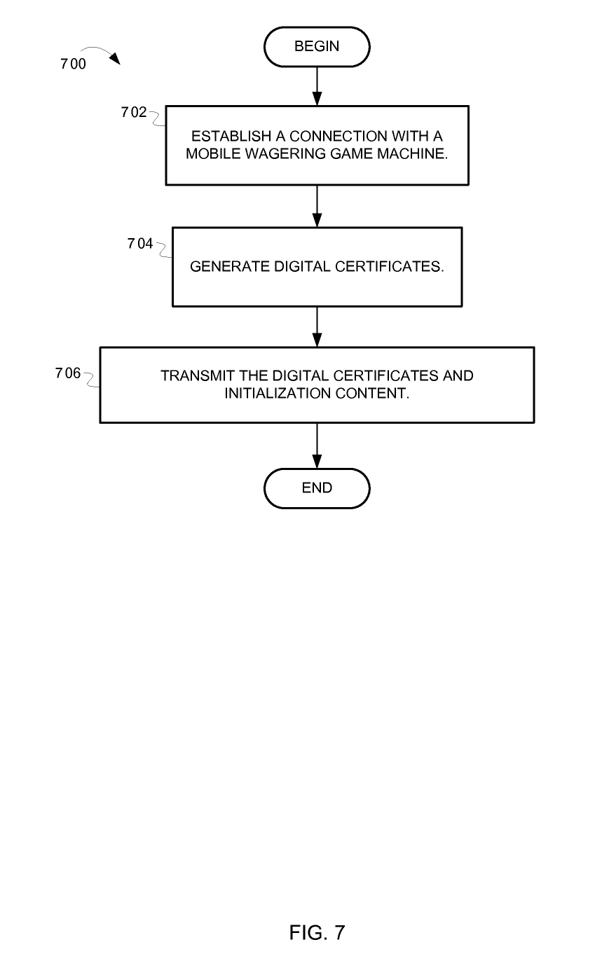

In the following discussion, FIG. 5 describes operations typically performed by mobile machines, whereas FIG. 6 describes operations typically performed by wagering game servers. FIGS. 7 & 8 describe operations typically performed by digital certificate servers.

### Mobile Machine Operations

FIG. 5 is a flow diagram illustrating operations for initializing a wagering game machine, according to some embodiments of the invention. The flow 500 will be described with reference to the embodiments shown in FIGS. 2-4. The flow 500 begins at block 502.

At block 502, a mobile machine 202 receives initialization content and a digital certificate over a secure network connection. In some embodiments, the mobile machine 202 receives the initialization content while connected to a gaming station 218. The initialization content can include a boot record and other operating system components. The digital certificate can include data described in the discussion of FIG. 4 and other suitable data. In some embodiments, the mobile machine 202 receives a single data packet from the initialization server 220, where the data packet includes the initialization content and a digital certificate. Alternatively, the mobile machine 202 can receive the initialization content and digital certificates in a plurality of data packets from the initialization server 220 and the digital certificate server 222. In some embodiments, the mobile machine receives more than one digital certificate. The flow continues at block 504.

At block 504, the mobile machine 202 and initializes using the initialization content. For example, the mobile machine 202 boots using a boot record received from the initialization server 220. After initialization, a player can check-out the mobile machine 202 from the gaming station 218. After check-out, the player can use the mobile machine 202 to play wagering games and receive services. The flow continues at block 506.

At block 506, the mobile machine 202 connects to a wagering game server 206. The mobile machine 202 may connect the wagering game server 206 to initiate a process for receiving wagering game content and/or services. The flow continues at block 508.

At block 508, the mobile machine 202 provides a digital certificate to the wagering game server 206. The digital certificate can include information indicating a validity period, public key, certificate issuer name, and content and/or services available to the wagering game machine 202. The digital certificate can conform to the X.509 standard. In addition to providing the digital certificate, the mobile machine 202 may also perform additional authentication operations (e.g., sending data signed by the mobile machine's private key). The flow continues at block 510.

At block 510, the mobile machine 202 determines whether the digital certificate was accepted. In some embodiments, the wagering game server 206 will not accept the digital certificate if the certificate is expired, revoked, or modified. If the certificate was not accepted, the flow ends. Otherwise, the flow continues at block 511.

At block 511, the mobile machine 202 performs additional authentication operations. For example, in some embodiments, the mobile machine 202 can receive a nonce from the wagering game server 206. Using the nonce and its private key 346, the mobile machine 202 can generate and send a hash to the wagering game server 206. In some embodiments, the wagering game server 206 can verify the hash using a public key included in the digital certificate provided at block 508. In some embodiments, these additional authentication operations enable the wagering game machine 206 to confirm that the mobile machine 202 has both a valid digital certificate and a private key associated with the digital certificate. The flow continues at block 512.

At block 512, the mobile machine 202 exchanges wagering game content with the wagering game server 206. The wagering game content can include instructions and/or data for conducting wagering games (e.g., video slots, video poker, video black jack, and the like). For example, the wagering game content can include program code, audio content, video content, language content, and/or other data used for conducting all or part of a wagering game and/or bonus games. The wagering game content can also include executable game code, game math, art, configuration data (enumerating allowable percentages, denominations, paylines, etc.), operating system features, device drivers, attract mode displays, advertisements, episodic game content, etc.

At block 514, using the wagering game content, the mobile machine 202 presents wagering games and/or provides services. For example, the mobile machine 202 can present a video slots game and/or bonus games using content received from the wagering game server 206. Additionally, the mobile machine 202 can provide concierge services, drink services, etc. The flow continues at block 516.

At block 516, if needed, the mobile machine 202 transmits a signal to maintain a connection with the wagering game server 206. In some embodiments, the mobile machine 202 sends the signal to indicate that it has not been tampered with or removed from the casino. The flow continues at block 518.

At block 518, the mobile machine 202 determines whether to terminate the flow 500. If the mobile machine 202 does not terminate the flow, the flow continues at block 512. Otherwise, the flow ends.

### Wagering Game Server Operations

This description continues by discussing how some wagering game servers interact with wagering game machines (e.g., mobile machines that perform the flow 500).

FIG. 6 is a flow diagram illustrating operations for processing digital certificates and exchanging wagering game content, according to some embodiments of the invention. The flow 600 begins at block 602.

At block 602, a wagering game server 206 establishes a communications connection (e.g., a wireless connection) with a wagering game network device, such as a mobile machine 202. The flow continues at block 604.

At block 604, the wagering game server 206 receives a digital certificate 400 from the mobile machine 202. As noted above, the digital certificate can include information indicating a validity period, public key, certificate issuer name, and content and/or services available to the wagering game machine 202. The flow continues at block 606.

At block 606, the wagering game server 206 determines whether the digital certificate 400 is expired or revoked. The wagering game server 206 can compare the digital certificate's validity period 402 against it's internal time and date information. Additionally, the wagering game server 206 can query a revocation list to determine whether the digital certificate has been revoked. In some embodiments, the wagering game server 206 maintains a list of revoked certificates, while in other embodiments, the digital certificate server 222 maintains the revocation list 226. The flow continues at block 608.

At block 608, the wagering game server 206 determines whether the digital certificate 400 is authentic. In some embodiments, if the wagering game server 206 can validate the digital certificate's digital signature 410, the digital certificate 400 is authentic. The wagering game server 206 can use the certificate authority's public key to validate the digital certificate's digital signature. If the digital certificate 400 is not authentic, the flow ends. Otherwise, the flow continues at block 609.

At block 609, the wagering game server 206 performs additional authentication operations. For example, in some embodiments, the wagering game server 206 sends a nonce to the mobile machine 202. In turn, the wagering game server 206 receives a hash generated from the nonce and the mobile machine's private key, where the private key is associated with the digital certificate received at bock 604. In some embodiments, the wagering game server 206 can verify the hash using a public key included in the digital certificate received at block 604. In some embodiments, these additional authentication operations enable the wagering game machine 206 to confirm that the mobile machine 202 has both a valid digital certificate and a private key associated with the digital certificate. The flow continues at block 610.

At block 610, the wagering game server 206 exchanges wagering game content with the mobile machine 202. In some embodiments, the wagering game server 206 uses information in the digital certificate (e.g., information in the available content and/or services filed 408) to determine what content to send to the mobile machine 202. As a result, the wagering game server 206 can use the digital certificate to determine what wagering games and services are available to the mobile machine 202. The flow continues at block 612.

At block 612, the wagering game server 206 determines whether it still has a communication connection with the mobile machine 202. In some embodiments, the wagering game server 206 checks the communication connection for security purposes (e.g., to determine whether the mobile machine 202 has been modified or removed from the casino). If the connection is lost, the flow continues at block 614. Otherwise, the flow continues at block 610.

At block 614, the wagering game server 206 requests that the mobile machine's digital certificate 400 be revoked. In some embodiments, the wagering game server sends this request to the digital certificate server 222. From block 614, the flow ends.

### Digital Certificate Server

This description continues with FIGS. 7 & 8, which describe how some digital certificate servers distribute and revoke digital certificates.

FIG. 7 is a flow diagram illustrating operations for distributing digital certificates in a wagering game network, according to some embodiments of the invention. In some embodiments, a digital certificate server performs the flow 700 as part of a process for initializing a mobile machine 202 (see discussion of block 502). The flow diagram 700 begins at block 702.

At block 702, the digital certificate server 222 establishes communications with a mobile machine 202. The flow continues at block 704.

At block 704, the digital certificate server 222 generates one or more digital certificates. The digital certificates can include root certificates and individual certificates. In some embodiments, the digital certificates include the information discussed in FIG. 4. In some embodiments, the digital certificate server 222 can also generate private keys for use by wagering game network devices. The flow continues at block 706.

At block 706, the digital certificate server 222 transmits the digital certificates to the mobile machine 202. In some embodiments, the digital certificate server 222 also transmits to the mobile machine 202 initialization content (e.g., a boot record) and/or a private key associated with the digital certificates. From block 706, the flow ends.

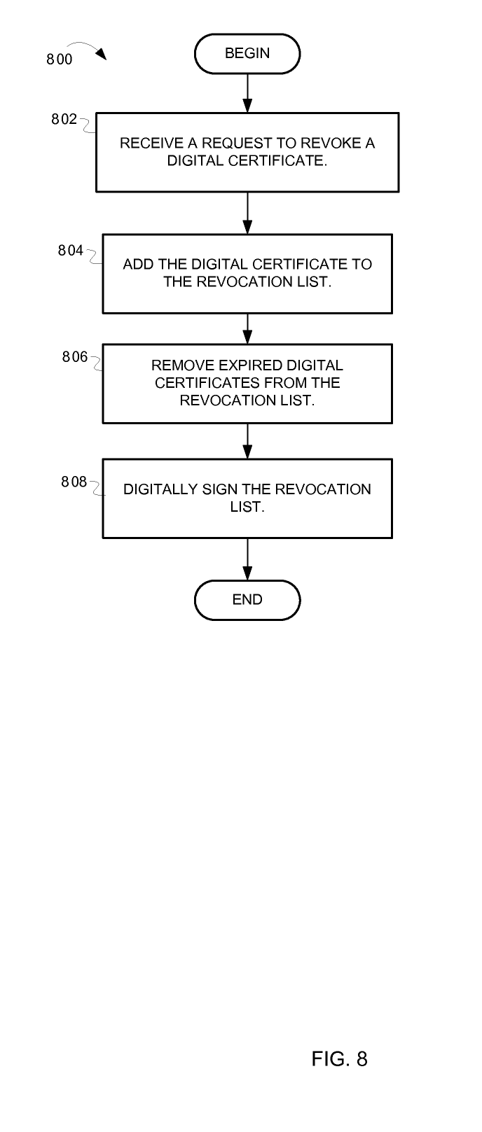

While FIG. 7 describes operations for distributing digital certificates, FIG. 8 describes operations for revoking digital certificates.

FIG. 8 is a flow diagram illustrating operations for processing a request to revoke a digital certificate, according to some embodiments of the invention. The flow 800 begins at block 802.

At block 802, the digital certificate server 222 receives a request to revoke a digital certificate. The request can originate from a wagering game server 206 or any other suitable device. In some embodiments, the revocation request explicitly identifies (e.g., by serial number) a digital certificate to revoke. The flow continues at block 804.

At block 804, the digital certificate server 222 modifies a list of revoked digital certificates to include the certificate for which revocation is requested. The flow continues at block 806.

At block 806, the digital certificate server 222 removes expired digital certificates from the revocation list. Deleting expired digital certificates from the revocation list can reduce overhead (e.g., system resources and processing time) associated with maintaining and searching the revocation list. In some embodiments, the digital certificate server 222 distributes the revocation list to other network devices (e.g., a wagering game server). The flow continues at block 808.

At block 808, the digital certificate server 222 digitally signs the revocation list using its private cryptographic key (e.g., the same key it uses for signing digital certificates). This digital signature can be used to authenticate the revocation list.

In some embodiments, entries are removed from the revocation list as part of a separate periodic process. Some embodiments leverage knowledge about expiration times to keep the revocation list relatively small. For example, digital certificates may be issued every hour, where the certificates expire after an hour. Thus, every hour, the digital certificate server 222 can remove expired digital certificates from the revocation list. The frequency with which digital certificates are removed can vary. In some embodiments, the digital certificate server 222 can set a process to delete expired certificates at a specified time.

From block 808, the flow ends.

### More About Wagering Game Machines

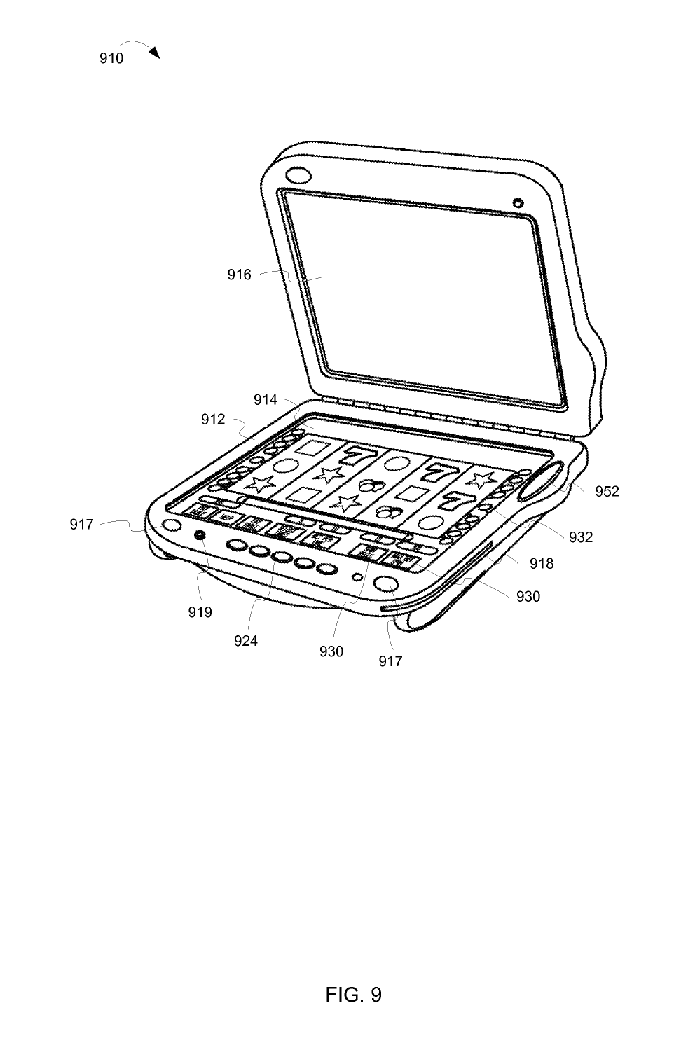

FIG. 9 shows an example embodiment of a wagering game machine, according to some embodiments of the invention. Like free standing wagering game machines, in a handheld or mobile form, the wagering game machine 910 can include any suitable electronic device configured to play a video casino games such as blackjack, slots, keno, poker, blackjack, and roulette. The wagering game machine 910 comprises a housing 912 and includes input devices, including a value input device 918 and a player input device 924. For output, the wagering game machine 910 includes a primary display 914, a secondary display 916, one or more speakers 917, one or more player-accessible ports 919 (e.g., an audio output jack for headphones, a video headset jack, etc.), and other conventional I/O devices and ports, which may or may not be player-accessible. In the embodiment depicted in FIG. 9, the wagering game machine 910 comprises a secondary display 916 that is rotatable relative to the primary display 914. The optional secondary display 916 can be fixed, movable, and/or detachable/attachable relative to the primary display 914. Either the primary display 914 and/or secondary display 916 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 918 can comprise, for example, a slot located on the front, side, or top of the housing 912 configured to receive credit from a stored-value card (e.g., casino card, smart card, debit card, credit card, etc.) inserted by a player. The player-accessible value input device 918 can also comprise a sensor (e.g., an RF sensor) configured to sense a signal (e.g., an RF signal) output by a transmitter (e.g., an RF transmitter) carried by a player. The player-accessible value input device 918 can also or alternatively include a ticket reader, or barcode scanner, for reading information stored on a credit ticket, a card, or other tangible portable credit or funds storage device. The credit ticket or card can also authorize access to a central account, which can transfer money to the wagering game machine 910.

Still other player-accessible value input devices 918 can require the use of touch keys 930 on the touch-screen display (e.g., primary display 914 and/or secondary display 916) or player input devices 924. Upon entry of player identification information and, preferably, secondary authorization information (e.g., a password, PIN number, stored value card number, predefined key sequences, etc.), the player can be permitted to access a player's account. As one potential optional security feature, the wagering game machine 910 can be configured to permit a player to only access an account the player has specifically set up for the wagering game machine 910. Other conventional security features can also be utilized to, for example, prevent unauthorized access to a player's account, to minimize an impact of any unauthorized access to a player's account, or to prevent unauthorized access to any personal information or funds temporarily stored on the wagering game machine 910.

The player-accessible value input device 918 can itself comprise or utilize a biometric player information reader which permits the player to access available funds on a player's account, either alone or in combination with another of the aforementioned player-accessible value input devices 918. In an embodiment wherein the player-accessible value input device 918 comprises a biometric player information reader, transactions such as an input of value to the wagering game machine 910, a transfer of value from one player account or source to an account associated with the wagering game machine 910, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 918 comprising a biometric player information reader can require a confirmatory entry from another biometric player information reader 952, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 918 can be provided remotely from the wagering game machine 910.

The player input device 924 comprises a plurality of push buttons on a button panel for operating the wagering game machine 910. In addition, or alternatively, the player input device 924 can comprise a touch screen mounted to a primary display 914 and/or secondary display 916. In one aspect, the touch screen is matched to a display screen having one or more selectable touch keys 930 selectable by a user's touching of the associated area of the screen using a finger or a tool, such as a stylus pointer. A player enables a desired function either by touching the touch screen at an appropriate touch key 930 or by pressing an appropriate push button on the button panel. The touch keys 930 can be used to implement the same functions as push buttons. Alternatively, the push buttons 926 can provide inputs for one aspect of the operating the game, while the touch keys 930 can allow for input needed for another aspect of the game. The various components of the wagering game machine 910 can be connected directly to, or contained within, the casing 912, as seen in FIG. 9, or can be located outside the casing 912 and connected to the housing 912 via a variety of wired (tethered) or wireless connection methods. Thus, the wagering game machine 910 can comprise a single unit or a plurality of interconnected (e.g., wireless connections) parts which can be arranged to suit a player's preferences.

The operation of the basic wagering game on the wagering game machine 910 is displayed to the player on the primary display 914. The primary display 914 can also display the bonus game associated with the basic wagering game. The primary display 914 preferably takes the form of a high resolution LCD, a plasma display, an LED, or any other type of display suitable for use in the wagering game machine 910. The size of the primary display 914 can vary from, for example, about a 2-3″ display to a 15″ or 17″ display. In at least some embodiments, the primary display 914 is a 7″-10″ display. In some embodiments, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 914 and/or secondary display 916 can have a 16:9 aspect ratio or other aspect ratio (e.g., 4:3). The primary display 914 and/or secondary display 916 can also each have different resolutions, different color schemes, and different aspect ratios.

As with the free standing embodiments a wagering gaming machine, a player begins play of the basic wagering game on the wagering game machine 910 by making a wager (e.g., via the value input device 918 or an assignment of credits stored on the handheld gaming machine via the touch screen keys 930, player input device 924, or buttons 926) on the wagering game machine 910. In some embodiments, the basic game can comprise a plurality of symbols arranged in an array, and includes at least one payline 932 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 918 of the wagering game machine 910 can double as a player information reader 952 that allows for identification of a player by reading a card with information indicating the player's identity (e.g., reading a player's credit card, player ID card, smart card, etc.). The player information reader 952 can alternatively or also comprise a bar code scanner, RFID transceiver or computer readable storage medium interface. In some embodiments, the player information reader 952 comprises a biometric sensing device.

In some embodiments, the wagering game machine 910 can include a heat spreader to cool its electronic components. In some embodiments, the heat spreader includes IsoSkinTM, which is available from Novel Concepts, Inc. In some embodiments, all or a portion of the wagering game machine's housing 912 includes IsoSkinTM or other suitable heat spreaders. The heat spreader can eliminate heat sinks and/or fans from some embodiments of the wagering game machine. In yet other embodiments, heat spreaders are disposed inside the housing 912 to dissipate heat generated by the machine's electronic components.

### General

This description describes numerous details about embodiments of the invention. However, some embodiments may be practiced without these specific details. In some instances, for sake of clarity, this description omits well-known circuits, structures and techniques. In this description, references to “one embodiment” or “an embodiment” mean that a feature is included in at least one embodiment of the invention. Furthermore, separate references to “one embodiment” do not necessarily refer to the same embodiment. Thus, the present invention can include any combination of embodiments described herein.

This description does not, therefore, limit embodiments of the invention, which are defined only by the appended claims. Each of the embodiments described herein are contemplated as falling within the inventive subject matter, which is set forth in the following claims.

1. A method comprising:
receiving, from a mobile wagering game machine, a digital certificate including authentication information, wherein the digital certificate also includes an available content field including access information identifying wagering game content that the mobile wagering game machine has permission to access;
authenticating the mobile wagering game machine based, at least in part, on the authentication information;
determining, from a library of wagering game content, the wagering game content that the mobile wagering game machine has permission to access, wherein the determining is based, at least in part, on the access information included in the available content field; and
enabling the mobile wagering game machine to access the wagering game content that the mobile wagering game machine has permission to access.

2. The method of claim 1, wherein the digital certificate conforms to an X.509 standard.

3. The method of claim 1, wherein the library includes content for a plurality of different wagering games.

4. The method of claim 1, further comprising:
transmitting, via a communications network to the mobile wagering game machine, a boot record and the digital certificate.

5. The method of claim 1, wherein the available content field also includes information identifying services that the mobile wagering game machine has permission to access.

6. The method of claim 1, wherein the digital certificate includes a public encryption key.

7. The method of claim 1, wherein the authenticating the mobile wagering game machine includes determining that the digital certificate is not revoked and not expired.

8. One or more computer readable storage media, having instructions stored therein, which, when executed by one or more processors, causes the one or more processors to perform operations that comprise:
receiving, via a communications network, a digital certificate for a mobile wagering game machine including one or more fields, one of the fields being an available content field indicating content that the mobile wagering game machine has permission to access;
accessing the available content field;
determining, from a content set, the content that the mobile wagering game machine has permission to access, wherein the determining is based on the available content field; and
enabling, via the communications network, the mobile wagering game machine to access the content that the mobile wagering game machine has permission to access.

9. The one or more computer readable storage media of claim 8, wherein the digital certificate conforms to an X.509 standard.

10. The one or more computer readable media of claim 8, wherein the content set includes content for a plurality of different wagering games.

11. The one or more computer readable storage media of claim 8, the operations further comprising:
transmitting, via the communications network to the mobile wagering game machine, a boot record and the digital certificate.

12. The one or more computer readable storage media of claim 8, wherein the available content field includes information identifying services that the mobile wagering game machine has permission to access.

13. The one or more computer readable media of claim 8, wherein the digital certificate includes a public encryption key.

14. The one or more computer readable storage media of claim 8, the operations further comprising:
authenticating the mobile wagering game machine based, at least in part, on authentication information contained in the digital certificate.

15. An apparatus comprising:
at least one processor, and;
a computer readable storage medium having computer usable program code executable on the at least one processor, the computer usable program code including code to:
receive, from a mobile wagering game machine, a digital certificate including authentication information, wherein the digital certificate also includes an available content field including access information identifying wagering game content that the mobile wagering game machine has permission to access;
authenticate the mobile wagering game machine based, at least in part, on the authentication information;
determine, from a library of wagering game content, the wagering game content that the mobile wagering game machine has permission to access, wherein the determination is based, at least in part, on the access information included in the available content field;
enable the mobile wagering game machine to access the wagering game content that the mobile wagering game machine has permission to access.

16. The apparatus of claim 15, wherein the digital certificate conforms to an X.509 standard.

17. The apparatus of claim 15, wherein the library includes content for a plurality of different wagering games.

18. The apparatus of claim 15, the computer usable program further including code to:
transmit, via a communications network to the mobile wagering game machine, a boot record and the digital certificate.

19. The apparatus of claim 15, wherein the available content field also includes information identifying services that the mobile wagering game machine has permission to access.

20. The apparatus of claim 15, wherein the digital certificate includes a public encryption key.
